(19) United States
(12) Patent Application Publication
(10) Pub. No.: US 2019/0036772 A1
(43) Pub. Date: Jan. 31, 2019

(54) INTELLIGENT WIRELESS CONFIGURATION FOR IOT DEVICES

(71) Applicant: Intel Corporation, Santa Clara, CA (US)

(72) Inventors: Mats Gustav Agerstam, Portland, OR (US); Robert Allan Colby, Granite Bay, CA (US)

(21) Appl. No.: 15/856,643

(22) Filed: Dec. 28, 2017

(51) Int. Cl. H04L 12/24; H04L 29/08; H04L 12/26; H04W 24/08; H04W 24/10

(52) U.S. Cl. CPC H04L 41/0816; H04L 67/12; H04W 24/10; H04W 24/08; H04L 43/0882

(57) ABSTRACT

A method for updating, at a first device, a reporting configuration of a second device in a wireless network environment may include accessing, at the first device, a current reporting configuration for a second device, wherein the second device transmits sensor data to the first device according to the reporting configuration; measuring network congestion of the wireless network environment surrounding the first device; based on the network congestion and the current reporting interval, determining an updated reporting configuration for the second device; and transmitting an instruction to the second device with the updated reporting interval.

### TECHNICAL FIELD

Embodiments described herein generally relate to processing techniques used with data communications and interconnected device networks, and in particular, to techniques applied within internet of things (IoT) devices and device networks.

### BACKGROUND

IoT devices are physical objects that may communicate on a network, and may include sensors, actuators, and other input/output components, such as to collect data or perform actions from a real world environment. For example, IoT devices may include low-powered devices that are embedded or attached to everyday things, such as buildings, vehicles, packages, etc., to provide an additional level of artificial sensory perception of those things. Recently, IoT devices have become more popular and thus applications using these devices have proliferated.

Various standards have been proposed to more effectively interconnect and operate IoT devices and IoT network use cases. These include the specialization of communication standards distributed by groups such as Institute of Electrical and Electronics Engineers (IEEE), and the specialization of application interaction architecture and configuration standards distributed by groups such as the Open Connectivity Foundation (OCF).

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 illustrates an domain topology for respective internet-of-things (IoT) networks coupled through links to respective gateways, according to various examples.

FIG. 2 illustrates a cloud computing network in communication with a mesh network of IoT devices operating as a fog device at the edge of the cloud computing network, according various examples.

FIG. 3 is a graph illustrating a relationship between the number of IoT devices, discovery latency, and reporting intervals in a network environment, according various examples.

FIG. 4 illustrates communications between a gateway and a sensor, according to various examples.

FIG. 5 illustrates a schematic of a network configuration, according to various examples.

FIG. 6 illustrates a schematic of a network configuration, according to various examples.

FIG. 7 illustrates a flowchart of a method to configure a device, according to various examples.

FIG. 8 illustrates a block diagram of a network illustrating communications among a number of IoT devices, according to various examples.

FIG. 9 illustrates a block diagram for an example IoT processing system architecture upon which any one or more of the techniques (e.g., operations, processes, methods, and methodologies) discussed herein may be performed, according various examples.

### DETAILED DESCRIPTION

In the following description, methods, configurations, and related apparatuses are disclosed for the dynamic modification of reporting intervals in an Internet-of-Things (IoT) device.

Various problems with existing IoT device reporting intervals are solved by the techniques described herein. For example, many IoT devices are low-power (e.g., battery powered) wireless devices that have a static reporting interval during which the devices transmit a data payload (e.g., sensor data, beacons). The static reporting interval may be set independent of the network congestion in a network environment. Thus, there may be times the data payload is not received at a receiving device due to the network congestion. The problem becomes compounded in enterprise environments where 100 or more IoT devices may be present within network communication range of each other. Accordingly, if all the IoT devices were adjusted to report more frequently, more data payloads may be lost due to the aggregate increase of reporting intervals. Additionally, if reports are sent more frequently, the IoT devices would deplete their batteries more quickly.

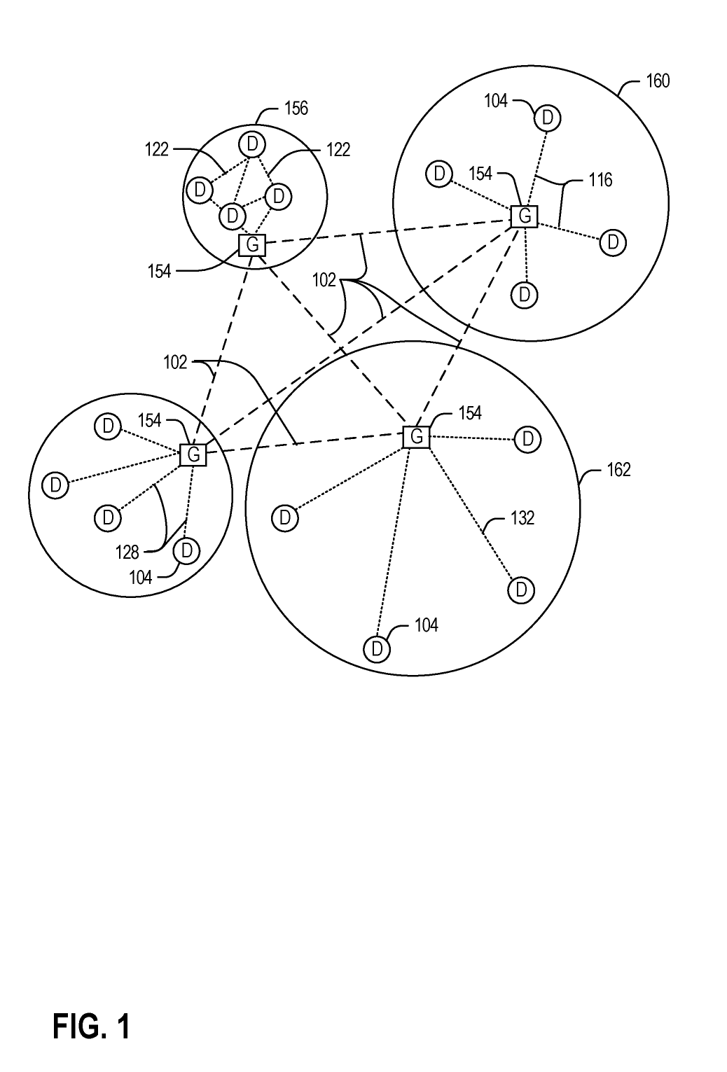

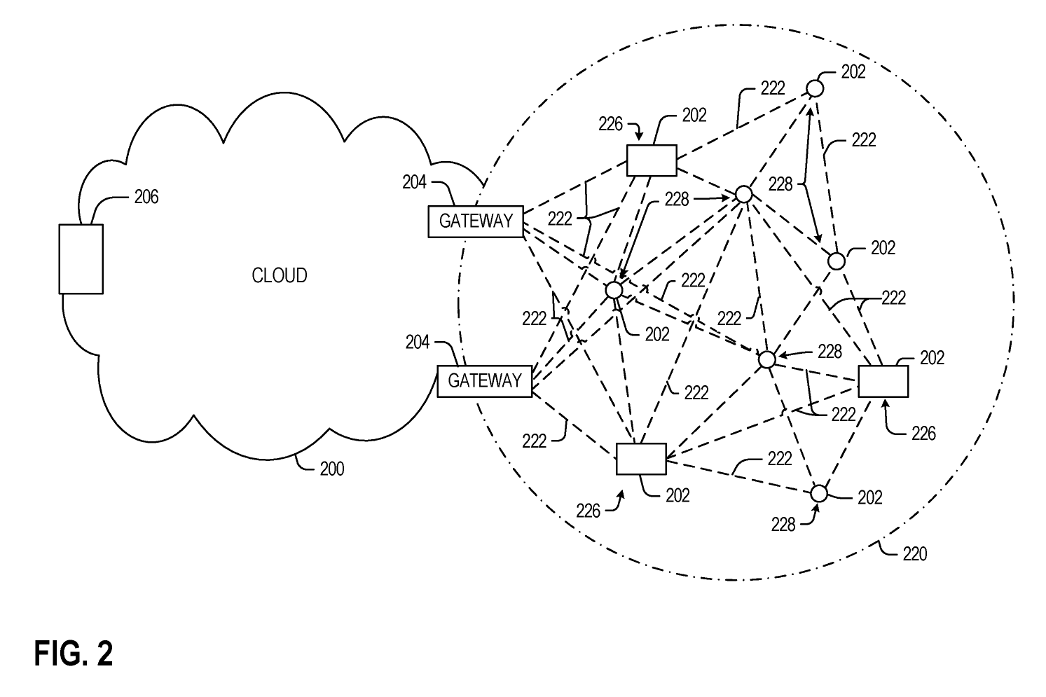

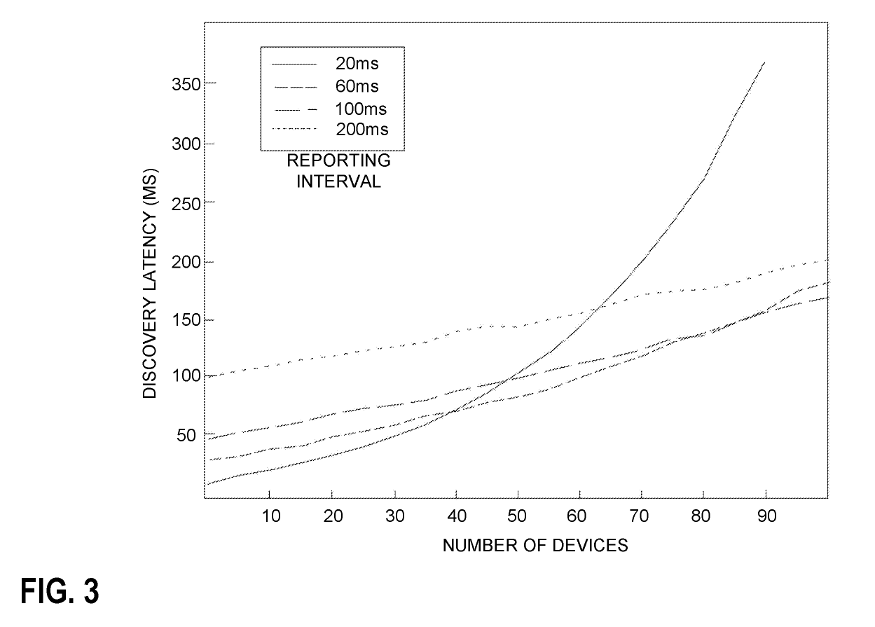

The techniques described herein alleviate these problems by using a gateway device to manage the reporting intervals of individual IoT devices based on current network congestion and optimizing battery life, among other factors, as described in more detail below. An initial description of example IoT and cloud networks are described in FIGS. 1 and 2, and then a more in-depth discussion of dynamically setting reporting intervals is presented with respect to FIGS. 3-7.

FIG. 1 illustrates an example domain topology for respective IoT networks coupled through links to respective gateways. The Internet of Things is a concept in which a large number of computing devices are interconnected to each other and to the Internet to provide functionality and data acquisition at very low levels. Thus, as used herein, an IoT device may include a semiautonomous device performing a function, such as sensing or control, among others, in communication with other IoT devices and a wider network, such as the Internet.

Often, IoT devices are limited in memory, size, or functionality, allowing larger numbers to be deployed for a similar cost to smaller numbers of larger devices. However, an IoT device may be a smart phone, laptop, tablet, or PC, or other larger device. Further, an IoT device may be a virtual device, such as an application on a smart phone or other computing device. IoT devices may include IoT gateways, used to couple IoT devices to other IoT devices and to cloud applications, for data storage, process control, and the like.

Networks of IoT devices may include commercial and home automation devices, such as water distribution systems, electric power distribution systems, pipeline control systems, plant control systems, light switches, thermostats, locks, cameras, alarms, motion sensors, and the like. The IoT devices may be accessible through remote computers, servers, and other systems, for example, to control systems or access data.

The future growth of the Internet and like networks may involve very large numbers of IoT devices. Accordingly, in the context of the techniques discussed herein, a number of innovations for such future networking will address the need for all these layers to grow unhindered, to discover and make accessible connected resources, and to support the ability to hide and compartmentalize connected resources. Any number of network protocols and communications standards may be used, wherein each protocol and standard is designed to address specific objectives. Further, the protocols are part of the fabric supporting human accessible services that operate regardless of location, time, or space. The innovations include service delivery and associated infrastructure, such as hardware and software; security enhancements; and the provision of services based on Quality of Service (QoS) terms specified in service level and service delivery agreements. As will be understood, the use of IoT devices and networks, such as those introduced in FIGS. 1 and 2, present a number of new challenges in a heterogeneous network of connectivity comprising a combination of wired and wireless technologies.

FIG. 1 provides a simplified drawing of a domain topology that may be used for a number of internet-of-things (IoT) networks comprising IoT devices 104, with the IoT networks 156, 158, 160, 162, coupled through backbone links 102 to respective gateways 154. For example, a number of IoT devices 104 may communicate with a gateway 154, and with each other through the gateway 154. To simplify the drawing, not every IoT device 104, or communications link (e.g., link 116, 122, 128, or 132) is labeled. The backbone links 102 may include any number of wired or wireless technologies, including optical networks, and may be part of a local area network (LAN), a wide area network (WAN), or the Internet. Additionally, such communication links facilitate optical signal paths among both IoT devices 104 and gateways 154, including the use of MUXing/deMUXing components that facilitate interconnection of the various devices.

The network topology may include any number of types of IoT networks, such as a mesh network provided with the network 156 using Bluetooth low energy (BLE) links 122. Other types of IoT networks that may be present include a wireless local area network (WLAN) network 158 used to communicate with IoT devices 104 through IEEE 802.11 (Wi-Fi®) links 128, a cellular network 160 used to communicate with IoT devices 104 through an LTE/LTE-A (4G) or 5G cellular network, and a low-power wide area (LPWA) network 162, for example, a LPWA network compatible with the LoRaWan specification promulgated by the LoRa alliance, or a IPv6 over Low Power Wide-Area Networks (LPWAN) network compatible with a specification promulgated by the Internet Engineering Task Force (IETF). Further, the respective IoT networks may communicate with an outside network provider (e.g., a tier 2 or tier 3 provider) using any number of communications links, such as an LTE cellular link, an LPWA link, or a link based on the IEEE 802.15.4 standard, such as Zigbee®. The respective IoT networks may also operate with use of a variety of network and internet application protocols such as Constrained Application Protocol (CoAP). The respective IoT networks may also be integrated with coordinator devices that provide a chain of links that forms cluster tree of linked devices and networks.

Each of these IoT networks may provide opportunities for new technical features, such as those as described herein. The improved technologies and networks may enable the exponential growth of devices and networks, including the use of IoT networks into as fog devices or systems. As the use of such improved technologies grows, the IoT networks may be developed for self-management, functional evolution, and collaboration, without needing direct human intervention. The improved technologies may even enable IoT networks to function without centralized controlled systems. Accordingly, the improved technologies described herein may be used to automate and enhance network management and operation functions far beyond current implementations.

In an example, communications between IoT devices 104, such as over the backbone links 102, may be protected by a decentralized system for authentication, authorization, and accounting (AAA). In a decentralized AAA system, distributed payment, credit, audit, authorization, and authentication systems may be implemented across interconnected heterogeneous network infrastructure. This allows systems and networks to move towards autonomous operations. In these types of autonomous operations, machines may even contract for human resources and negotiate partnerships with other machine networks. This may allow the achievement of mutual objectives and balanced service delivery against outlined, planned service level agreements as well as achieve solutions that provide metering, measurements, traceability and trackability. The creation of new supply chain structures and methods may enable a multitude of services to be created, mined for value, and collapsed without any human involvement.

Such IoT networks may be further enhanced by the integration of sensing technologies, such as sound, light, electronic traffic, facial and pattern recognition, smell, vibration, into the autonomous organizations among the IoT devices. The integration of sensory systems may allow systematic and autonomous communication and coordination of service delivery against contractual service objectives, orchestration and quality of service (QoS) based swarming and fusion of resources. Some of the individual examples of network-based resource processing include the following.

The mesh network 156, for instance, may be enhanced by systems that perform inline data-to-information transforms. For example, self-forming chains of processing resources comprising a multi-link network may distribute the transformation of raw data to information in an efficient manner, and the ability to differentiate between assets and resources and the associated management of each. Furthermore, the proper components of infrastructure and resource based trust and service indices may be inserted to improve the data integrity, quality, assurance and deliver a metric of data confidence.

The WLAN network 158, for instance, may use systems that perform standards conversion to provide multi-standard connectivity, enabling IoT devices 104 using different protocols to communicate. Further systems may provide seamless interconnectivity across a multi-standard infrastructure comprising visible Internet resources and hidden Internet resources.

Communications in the cellular network 160, for instance, may be enhanced by systems that offload data, extend communications to more remote devices, or both. The LPWA network 162 may include systems that perform non-Internet protocol (IP) to IP interconnections, addressing, and routing. Further, each of the IoT devices 104 may include the appropriate transceiver for wide area communications with that device. Further, each IoT device 104 may include other transceivers for communications using additional protocols and frequencies. This is discussed further with respect to the communication environment and hardware of an IoT processing device depicted in FIGS. 12 and 13.

Finally, clusters of IoT devices may be equipped to communicate with other IoT devices as well as with a cloud network. This may allow the IoT devices to form an ad-hoc network between the devices, allowing them to function as a single device, which may be termed a fog device. This configuration is discussed further with respect to FIG. 2 below.

FIG. 2 illustrates a cloud computing network in communication with a mesh network of IoT devices (devices 202) operating as a fog device at the edge of the cloud computing network. The mesh network of IoT devices may be termed a fog 220, operating at the edge of the cloud 200. To simplify the diagram, not every IoT device 202 is labeled.

The fog 220 may be considered to be a massively interconnected network wherein a number of IoT devices 202 are in communications with each other, for example, by radio links 222. As an example, this interconnected network may be facilitated using an interconnect specification released by the Open Connectivity Foundation™ (OCF). This standard allows devices to discover each other and establish communications for interconnects. Other interconnection protocols may also be used, including, for example, the optimized link state routing (OLSR) Protocol, the better approach to mobile ad-hoc networking (B.A.T.M.A.N.) routing protocol, or the OMA Lightweight M2M (LWM2M) protocol, among others.

Three types of IoT devices 202 are shown in this example, gateways 204, data aggregators 226, and sensors 228, although any combinations of IoT devices 202 and functionality may be used. The gateways 204 may be edge devices that provide communications between the cloud 200 and the fog 220, and may also provide the backend process function for data obtained from sensors 228, such as motion data, flow data, temperature data, and the like. The data aggregators 226 may collect data from any number of the sensors 228, and perform the back-end processing function for the analysis. The results, raw data, or both may be passed along to the cloud 200 through the gateways 204. The sensors 228 may be full IoT devices 202, for example, capable of both collecting data and processing the data. In some cases, the sensors 228 may be more limited in functionality, for example, collecting the data and allowing the data aggregators 226 or gateways 204 to process the data.

Communications from any IoT device 202 may be passed along a convenient path (e.g., a most convenient path) between any of the IoT devices 202 to reach the gateways 204. In these networks, the number of interconnections provide substantial redundancy, allowing communications to be maintained, even with the loss of a number of IoT devices 202. Further, the use of a mesh network may allow IoT devices 202 that are very low power or located at a distance from infrastructure to be used, as the range to connect to another IoT device 202 may be much less than the range to connect to the gateways 204.

The fog 220 provided from these IoT devices 202 may be presented to devices in the cloud 200, such as a server 206, as a single device located at the edge of the cloud 200, e.g., a fog device. In this example, the alerts coming from the fog device may be sent without being identified as coming from a specific IoT device 202 within the fog 220. In this fashion, the fog 220 may be considered a distributed platform that provides computing and storage resources to perform processing or data-intensive tasks such as data analytics, data aggregation, and machine-learning, among others.

In some examples, the IoT devices 202 may be configured using an imperative programming style, e.g., with each IoT device 202 having a specific function and communication partners. However, the IoT devices 202 forming the fog device may be configured in a declarative programming style, allowing the IoT devices 202 to reconfigure their operations and communications, such as to determine needed resources in response to conditions, queries, and device failures. As an example, a query from a user located at a server 206 about the operations of a subset of equipment monitored by the IoT devices 202 may result in the fog 220 device selecting the IoT devices 202, such as particular sensors 228, needed to answer the query. The data from these sensors 228 may then be aggregated and analyzed by any combination of the sensors 228, data aggregators 226, or gateways 204, before being sent on by the fog 220 device to the server 206 to answer the query. In this example, IoT devices 202 in the fog 220 may select the sensors 228 used based on the query, such as adding data from flow sensors or temperature sensors. Further, if some of the IoT devices 202 are not operational, other IoT devices 202 in the fog 220 device may provide analogous data, if available.

FIG. 3 is a graph illustrating an example relationship between the number of IoT devices, discovery latency, and reporting interval in a network environment. As illustrated, a 20 ms reporting interval may be optimal when there are 40 devices or fewer in a given network environment. However, when the number of devices increases, the 20 ms reporting interval becomes a hindrance and leads to an increase of discovery latency compared to longer (e.g., 60 ms, 100 ms, or 200 ms) reporting intervals. Thus, FIG. 3 illustrates the problem of using a global reporting interval. In other words, what may lead to optimal results in one network environment may be detrimental (e.g., high battery use and lower discovery latency) in another network environment.

To further illustrate the problems with non-dynamic management of reporting intervals (e.g., an advertising interval), consider the following. An ideal case may be to provide a spread over the reporting interval, every N seconds, uniformly without any central authority enforcing as to reduce Over-the-Air (OTA) protocol complexity and orchestration and reduce complexity. An attempt to meet this objective may be to autonomously try to randomize each sensor's reporting to a gateway over the reporting interval N. Thus, it may be possible to evenly spread the sensor reporting over the N seconds with growing accuracy as the number of sensors grows. However, as the number of sensors grow, the number of advertising channels for each sensor may be too small for the number of sensors, causing report (e.g., beacon) loss even using randomized reporting intervals. This may lead to, increased power consumption, inefficient spectrum usage, unnecessary report delays, or reduced success probability for received reports.

To mitigate the impact seen above, an IoT gateway may manage the communication of the sensors in its environment. The gateway may scan the environment and calculate what an optimized network may be that still enables an end user to get updates in a timely manner.

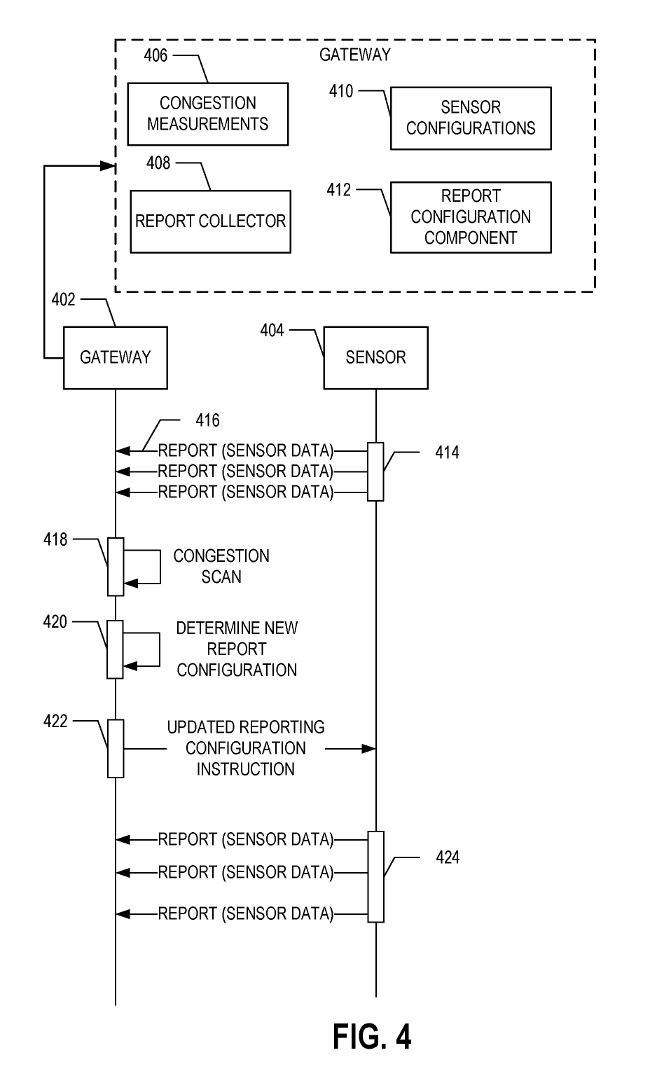

FIG. 4 illustrates communications between a gateway 402 and a sensor 404, according to various examples. Gateway 402 may include congestion measurements 406, report collector 408, sensor configurations 410, and report configuration component 412 (collectively, the gateway components). An overview of the communications includes sensor 404 transmitting three reports 416 during current reporting interval 414. Gateway 402 performs congestion scan 418 after which report configuration determination 420 determines an updated report configuration. Gateway 402 transmits, wirelessly, an updated reporting configuration instruction 422 to sensor 404. Subsequently, sensor 404 begins to transmit reports during updated reporting interval 424.

The functionality of the gateway components described herein may be performed by executing machine-readable instructions on processing circuitry (e.g., at least one core of a central processing unit, an application-specific instruction circuit, a graphical processing unit, system on a chip (SOC), etc.) of gateway 402. In some examples, the functionality may be performed by a processing unit of an external device that is communicatively coupled to gateway 402.

FIG. 4 may be discussed in the context of a Bluetooth low energy (BLE) link between gateway 402 and sensor 404 as described in greater detail in FIG. 1, but other communication link types may be used without departing from the scope of this disclosure. Similarly, sensor 404 is described purposes as an IoT temperature sensor, but other IoT device types may be used.

Congestion measurements 406 may include data collected about the network environment surrounding gateway 402. A data storage device (not illustrated) may be used to stored congestion measurements 406. Different types of metrics may be used to measure network congestion including, but not limited to:
RSSI (Received Signal Strength)
SNR (Signal-to Noise-Ratio)
PRR (Packet Reception Rate)/PER
LQI (Link Quality Indicator) per 802.15.4

Another network congestion measurement may be a calculated success rate. The success rate, in an example, may be based on the number of received reports 416 (R) received at gateway 402 during current reporting interval 414. R may be compared to the expected number of reports (C) for sensor 404. The expected number of reports may be retrieved from sensor configurations 410. Each sensor may have an identifier that is transmitted as part of a report that may be used to look up the expected number of reports. In other examples, the expected number of reports is transmitted with a report. In either case, the success rate may be considered R/C. Variations of R/C may be used for the success rate—such as averaging the number of received reports over multiple reporting intervals.

Congestion scan 418 may obtain data for congestion measurements 406 and occur periodically (e.g., every five minutes) or on-demand. The period may be stored as preference on gateway 402. The period may be dynamically adjusted according to current congestion levels. For example, if the congestion is above a certain threshold metric, the period between readings may be decreased as to avoid introducing even more congestion. On-demand may include taking a measurement when report configuration component 412 is used to determine an updated reporting configuration for one or more sensors. Congestion measurements 406 may also be time-stamped at the time of collection in order to preform further analysis in conjunction with report configurations.

Report collector 408 may store (e.g., on gateway 402) sensor data transmitted by sensor 404 during the reporting interval. The sensor data may be, for example, temperature readings of sensor 404. Report collector 408 may also relay the sensor data to another device for further processing. The location(s) of where to relay the collected sensor data may be stored in sensor configurations 410.

In addition to the data already described, sensor configurations 410 may store (e.g., on a storage device of sensor 404) historical performance metrics of sensor 404. Historical performance metrics may include the number of reports received during past reporting intervals, correlated with the expected number of expected reports. Accordingly, sensor configurations 410 may store current and past reporting configurations for sensor 404—as well as any other sensors gateway 402 is communicatively coupled to.

Sensor configurations 410 may also include data identifying the effect of different reporting intervals, number of reports during a reporting intervals, signal strength, or transmission power, as correlated with a given battery for a given sensor. For example, the data may indicate that a temperature sensor by ACME having product ID “123” has a 2.5 month battery life using a 100 ms reporting interval for a 240 mAh CR2032 battery. Sensor manufacturers may release datasheets for a sensor that detail these effects or the data may be collected from a third-party source. Thus, as discussed further below, gateway 402 may access these tables when determining an updated reporting configuration for a sensor.

Gateway 402 may augment or modify the datasheets based on observed effects on battery life for a sensor over time. For example, gateway 402 may receive a current battery level for sensor 404 with a report. The battery life may be tracked over multiple reporting intervals to observe the change in battery life. Hence, the tables for sensor 404 may be updated to indicate the actual battery life loss correlated with the reporting configuration for sensor 404. Some communication protocols may not support the concept of sending multiple reports per reporting interval. In such cases, it may be assumed that the number of reports per reporting intervals is one.

Report configuration component 412 may be used to manage the report configurations of a set of sensors (e.g., sensor 404) that gateway 402 is responsible for. Responsibility may be set prior to report configuration component 412 managing report configurations. For examples, a management dashboard may be used to define which sensors are managed by which gateways. The management dashboard may be implemented as a webpage, application, etc., that is communicatively coupled to the gateways. In some instances, each gateway may have its own managements dashboard that is served (e.g., a webpage) from the respective gateway.

The management dashboard may include options to select one or more sensors that are current in communication range of gateway 402 and the respective signal strength of each of the sensor. Thus, the user may select all the sensors that are above a certain signal strength for gateway 402 to manage and may select a different gateway for the remaining sensors. In other examples, selection of which sensors to manage may be set algorithmically (e.g., using rule logic).

The management dashboard may also include user interface (UI) elements (e.g., drop-down menus, text boxes, etc.) to define a target function with respect to report collection. The target function may be used by report configuration component 412 to manage the report configurations for gateway 402's managed sensor. A user may select from one or more of, number of reports per hour, success rate, battery life, and the like. Accordingly, a user may define the function as having six reports per hour with a 99% probability of success. The target function may be set for a single managed sensor, a subset of the managed sensors, or all of the managed sensors (e.g., selecting using UI elements). The defined target function(s) may be stored by report configuration component 412.

Accordingly, given a target function, report configuration determination 420 may determine an updated report configuration for sensor 404 and transmit an updated reporting configuration instruction 422. The instruction may also include a change to the number of reports per reporting interval. A number of techniques may be used to determine the updated report configuration including, but not limited to, algorithmically, lookup tables, preset adjustments, and the like.

As an example, consider that network congestion is measured using packet loss over period N. Then, it can be calculated what the percentage chance one report over period N will arrive at gateway 402. Using an example target function of five reports per hour with 99% chance of success, the reporting interval may be set to ⅕ of an hour (12 minutes). Then, given the packet loss, it may be calculated how many reports need to be sent over each 12-minute interval to achieve the 99% success rate.

In another example, consider that network congestion is determined by RSSI. Then, a lookup table may be used to determine what reporting interval is needed to achieve the desired success rate given the RSSI and type of sensor.

In various examples, lookup tables may not be available for a given sensor type and there may not be enough historical data to determine how a sensor performs in a certain network environment. In such instance, gateway 402 may make adjustments to reporting configuration using preset adjustments. The preset adjustments may be managed by the management dashboard. When a sensor is not meeting the target function, the preset adjustment may be to increase the number of reports per reporting interval by one. When a sensor is consistently (e.g., over multiple reporting intervals) meeting the target function, the preset adjustment may be to decrease the number of reports per reporting interval by one to see if battery use may be reduced. The performance of the sensor in the different network environments and reporting configurations may be stored. Thus, over time, the performance of the sensor in different network environments may be learned such that lookup tables may be used instead of preset adjustments.

In various examples, report configuration component 412 may optimize for battery life. Thus, the minimum reporting period and reports per period that achieves the target function may be used for a given network environment's congestion. Accordingly, as network congestion lessens, there may be instances in which report configuration component 412 reduces the number of reports per reporting period for a sensor.

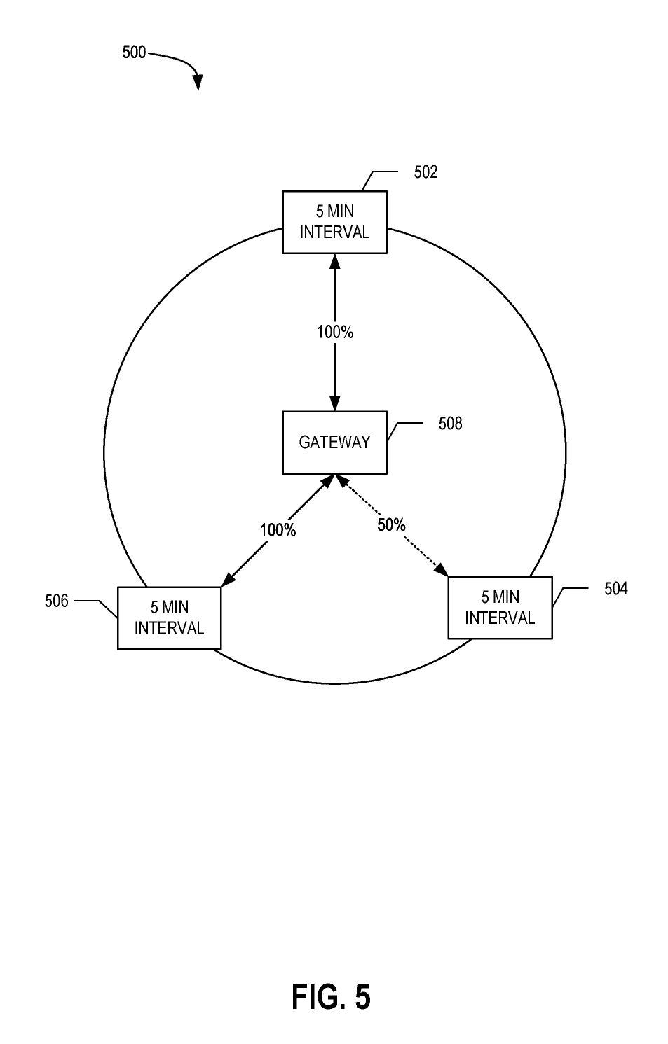

FIG. 5 illustrates a schematic of a network configuration 500, according to various examples. Network configuration 500 includes devices 502, 504, and 506 that are communicatively coupled to gateway 508. Devices 502, 504, and 506 may be IoT devices. Gateway 508 may include components such as those described with respect to gateway 402. Devices 502, 504, and 506 all have a 5-minute reporting interval. A configuration such as illustrated in FIG. 5 may have been the result of a user setting a static 5-minute reporting interval. However, although device 502 and device 506 have a 100% success rate in reporting to gateway 508, device 504 only has a 50% success rate. Thus, the static setting is leading to degraded performance.

Without a managed gateway such as described above, a user may attempt to fix the problem in network configuration 500 using a number of non-optimal choices. For example, the user may manually figure out which devices are not meeting reporting expectations (e.g., have less than an acceptable success rate) and change their settings. This is an unrealistic option considering the constant change of RF. Another option may be to increase all reporting intervals to attempt to make up for specific devices (e.g., device 504) that have loss. This may compound the problem (congestion), as well as impact battery life for devices that are now transmitting more frequently than needed. A third option may be to accept the variable loss.

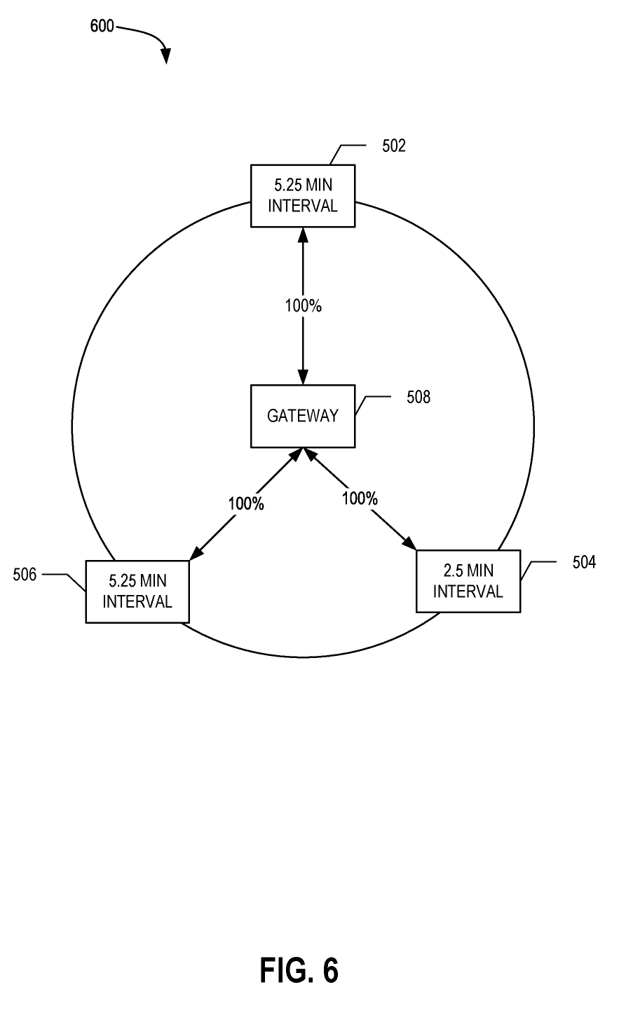

FIG. 6 illustrates a schematic of a network configuration 600, according to various examples. Network configuration 600 may be the result of gateway 508 determining new report configurations for devices 502, 504, and 506. Here, gateway 508 may assess the device requirements (e.g., a successful report every 5 minutes for device 504), and as such, is able to rebalance the network configuration to ensure that the user requirements are being met in an optimum way. Here, the reporting interval for device 504 has been reduced to 2 minutes and 30 seconds. This has led to an average success rate of at least one successful report every five minutes. Additionally, the reporting intervals of device 502 and device 506 have been slightly increased because at five minutes there was already a 100% success—implying there may have been room to increase the interval without additional loss. Accordingly, network configuration 600 may be a balanced network that does not introduce unnecessary congestion or impact device battery life.

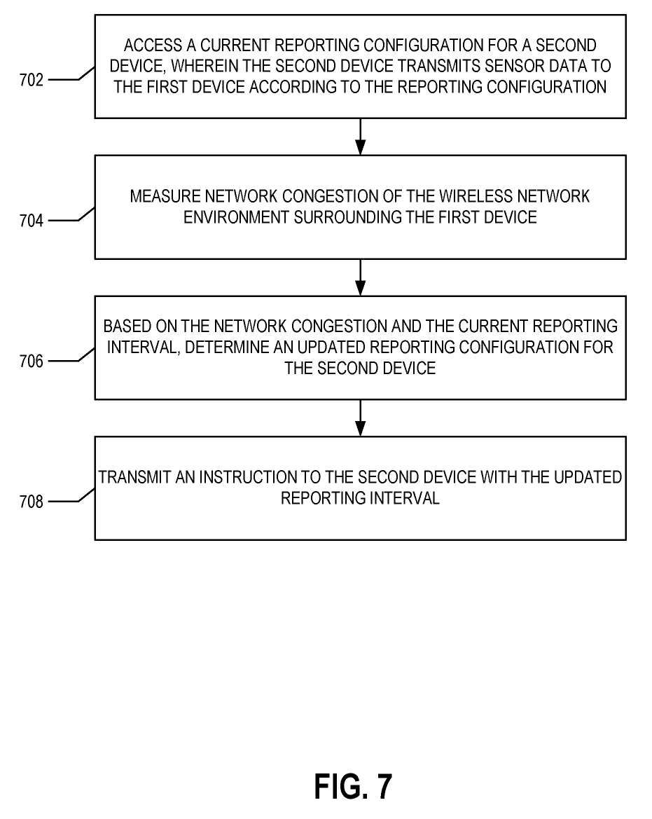

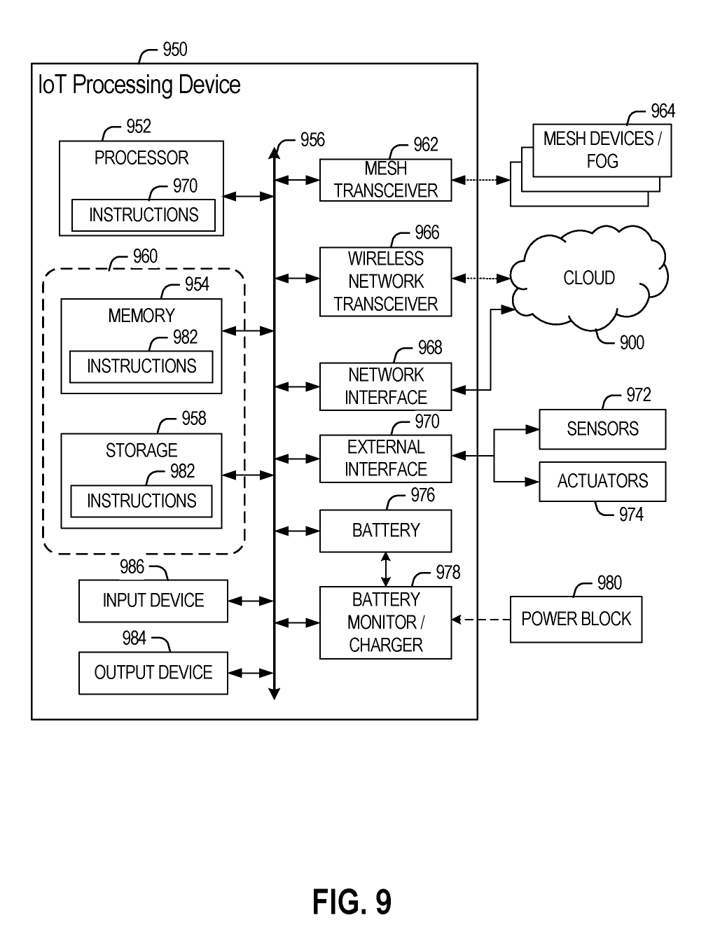

FIG. 7 illustrates is a flowchart of a method to configure a device, according to various examples. The method may be embodied in a set of instructions stored in at least one non-transitory storage device of a computing device(s). The computing device(s) may have one or more processors (e.g., processing circuitry) that execute the set of instructions to configure the one or more processors to perform the operations illustrated in FIG. 7. To this end, the one or more processors may instruct other parts of the computing device to carry out the set of instructions. For example, the computing device may instruct a network device to transmit data to another computing device or the computing device may provide data over a display interface to present a user interface. In some example, performance of the method may be split across multiple computing devices. The computing devices may of a type illustrated in FIG. 9 or an IoT gateway, according to various examples.

At operation 702, in various examples, a current reporting configuration for a second device may be accessed. For example, the current reporting configuration may be retrieved at the first device. The first device may be a gateway device as described with respect to FIG. 4. The second device may be an IoT device, such as a sensor. The first and second devices may communicate wirelessly in a network environment. For example, the second device may transmit reports (e.g., sensor data of the second device) periodically during a reporting interval (e.g., an advertising interval) that has been established for the second device.

A reporting configuration may identify values for a reporting interval (e.g., 500 ms) and, in some examples, how many reports to transmit during the reporting interval. The current reporting configuration may be retrieved from a data store (e.g., database, table, etc.) stored on the first device. When a report arrives at the first device, the report may include a device identifier (e.g., type, model number, network address, etc.) that may be used to query the data store for the current reporting configuration. In some examples, current reporting configuration may be transmitted from the second device to the first device.

At operation 704, in various examples, congestion surrounding (e.g., able to be sensed by) the first device may be measured in the wireless network environment. Congestion may be measured in a number of manners, including RSSI, SNR, PRR/PER, or LQI (Link Quality Indicator) per 802.15.4. In some examples congestion may be measured by calculating a success metric for the second device. The success metric may be based on comparing a number of reports received during the current reporting interval to an expected number of reports for the current reporting interval. The expected number may accessed from the current reporting configuration for the second device.

At operation 706, in various examples, an updated reporting configuration for the second device may be determined based on the network congestion and the current reporting interval. The updated reporting configuration may include modified values for the current reporting configuration of the second device. For example, the updated reporting configuration may include an updated reporting interval. Accordingly, the use of terms “current” and “updated” signify changes in values of the underlying reporting configuration as opposed to two stored reporting configurations.

The updated reporting interval may be retrieved from a data store (e.g., a lookup table) based on the network congestion and a type of the second device. In various examples, the updated reporting configuration may include determining an updated number of reports to transmit during the current reporting interval. For example, if the success metric indicates only 50% of the expected reports are arriving at the second device, the number of reports may be increased by a predetermined amount. In an example, if the success rate is below a threshold, the number of reports may be increased.

In various examples, the current reporting configuration may include a target success rate (e.g., target function) for the second device. Furthermore, determining the updated reporting configuration for the second device may additionally be based on the target success rate. For example, even though the success metric may be 60%, the target success rate may be 50% so no change in the reporting configuration may be needed. Or, the number of reports may adjusted downwards to conserve battery life. The target success rate may be stored as associated with the second device or with multiple devices.

More than two devices may be present in the network environment. For example, a current reporting configuration for a third device may be accessed at the first device. The third device may transmit sensor data to the first device according to the reporting configuration. Then, based on the network congestion, the current reporting interval for the third device and a target success rate for the third device, an updated reporting configuration for the third device may be determined. The updated reporting configuration for the second device may be an increase in a reporting interval and the updated reporting configuration for the third device may be a decrease in a reporting interval.

At operation 708, in various examples, an instruction to the second device with the updated reporting interval is transmitted. The transmission format may be set according to an API of the second device. The instruction may be encoded as a set of values (e.g., [reporting interval], [number of reports]).

In other examples, the operations and functionality described above with reference to FIGS. 3 to 7 may be embodied by a IoT device machine in the example form of an electronic processing system, within which a set or sequence of instructions may be executed to cause the electronic processing system to perform any one of the methodologies discussed herein, according to an example embodiment. The machine may be an IoT device or an IoT gateway, including a machine embodied by aspects of a personal computer (PC), a tablet PC, a personal digital assistant (PDA), a mobile telephone or smartphone, or any machine capable of executing instructions (sequential or otherwise) that specify actions to be taken by that machine. Further, while only a single machine may be depicted and referenced in the example above, such machine shall also be taken to include any collection of machines that individually or jointly execute a set (or multiple sets) of instructions to perform any one or more of the methodologies discussed herein. Further, these and like examples to a processor-based system shall be taken to include any set of one or more machines that are controlled by or operated by a processor (e.g., a computer) to individually or jointly execute instructions to perform any one or more of the methodologies discussed herein.

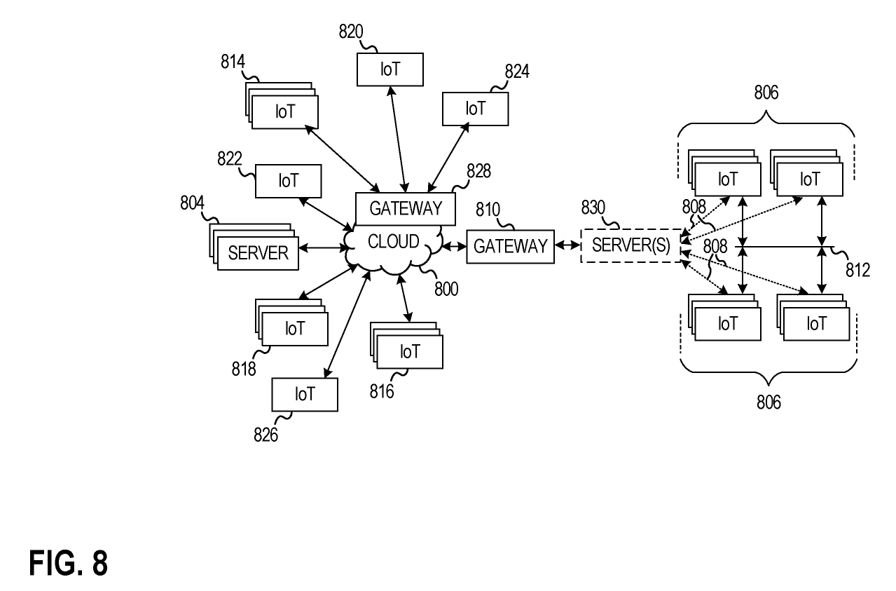

FIG. 8 illustrates a drawing of a cloud computing network, or cloud 800, in communication with a number of Internet of Things (IoT) devices. The cloud 800 may represent the Internet, or may be a local area network (LAN), or a wide area network (WAN), such as a proprietary network for a company. The IoT devices may include any number of different types of devices, grouped in various combinations. For example, a traffic control group 806 may include IoT devices along streets in a city. These IoT devices may include stoplights, traffic flow monitors, cameras, weather sensors, and the like. The traffic control group 806, or other subgroups, may be in communication with the cloud 900 through wired or wireless links 808, such as LPWA links, optical links, and the like. Further, a wired or wireless sub-network 812 may allow the IoT devices to communicate with each other, such as through a local area network, a wireless local area network, and the like. The IoT devices may use another device, such as a gateway 810 or 828 to communicate with remote locations such as the cloud 800; the IoT devices may also use one or more servers 830 to facilitate communication with the cloud 800 or with the gateway 810. For example, the one or more servers 830 may operate as an intermediate network node to support a local edge cloud or fog implementation among a local area network. Further, the gateway 828 that is depicted may operate in a cloud-to-gateway-to-many edge devices configuration, such as with the various IoT devices 814, 820, 824 being constrained or dynamic to an assignment and use of resources in the cloud 800.

Other example groups of IoT devices may include remote weather stations 814, local information terminals 816, alarm systems 818, automated teller machines 820, alarm panels 822, or moving vehicles, such as emergency vehicles 824 or other vehicles 826, among many others. Each of these IoT devices may be in communication with other IoT devices, with servers 804, with another IoT fog device or system (not shown, but depicted in FIG. 2), or a combination therein. The groups of IoT devices may be deployed in various residential, commercial, and industrial settings (including in both private or public environments).

As can be seen from FIG. 8, a large number of IoT devices may be communicating through the cloud 800. This may allow different IoT devices to request or provide information to other devices autonomously. For example, a group of IoT devices (e.g., the traffic control group 806) may request a current weather forecast from a group of remote weather stations 814, which may provide the forecast without human intervention. Further, an emergency vehicle 824 may be alerted by an automated teller machine 820 that a burglary is in progress. As the emergency vehicle 824 proceeds towards the automated teller machine 820, it may access the traffic control group 806 to request clearance to the location, for example, by lights turning red to block cross traffic at an intersection in sufficient time for the emergency vehicle 824 to have unimpeded access to the intersection.

Clusters of IoT devices, such as the remote weather stations 814 or the traffic control group 806, may be equipped to communicate with other IoT devices as well as with the cloud 800. This may allow the IoT devices to form an ad-hoc network between the devices, allowing them to function as a single device, which may be termed a fog device or system (e.g., as described above with reference to FIG. 2).

FIG. 9 is a block diagram of an example of components that may be present in an IoT device 950 for implementing the techniques described herein. The IoT device 950 may include any combinations of the components shown in the example or referenced in the disclosure above. The components may be implemented as ICs, portions thereof, discrete electronic devices, or other modules, logic, hardware, software, firmware, or a combination thereof adapted in the IoT device 950, or as components otherwise incorporated within a chassis of a larger system. Additionally, the block diagram of FIG. 9 is intended to depict a high-level view of components of the IoT device 950. However, some of the components shown may be omitted, additional components may be present, and different arrangement of the components shown may occur in other implementations.

The IoT device 950 may include a processor 952, which may be a microprocessor, a multi-core processor, a multithreaded processor, an ultra-low voltage processor, an embedded processor, or other known processing element. The processor 952 may be a part of a system on a chip (SoC) in which the processor 952 and other components are formed into a single integrated circuit, or a single package, such as the Edison™ or Galileo™ SoC boards from Intel. As an example, the processor 952 may include an Intel® Architecture Core™ based processor, such as a Quark™, an Atom™, an i3, an i5, an i7, or an MCU-class processor, or another such processor available from Intel® Corporation, Santa Clara, Calif. However, any number other processors may be used, such as available from Advanced Micro Devices, Inc. (AMD) of Sunnyvale, Calif., a MIPS-based design from MIPS Technologies, Inc. of Sunnyvale, Calif., an ARM-based design licensed from ARM Holdings, Ltd. or customer thereof, or their licensees or adopters. The processors may include units such as an A5-A10 processor from Apple® Inc., a Snapdragon™ processor from Qualcomm® Technologies, Inc., or an OMAP™ processor from Texas Instruments, Inc.

The processor 952 may communicate with a system memory 954 over an interconnect 956 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In various implementations the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 958 may also couple to the processor 952 via the interconnect 956. In an example the storage 958 may be implemented via a solid state disk drive (SSDD). Other devices that may be used for the storage 958 include flash memory cards, such as SD cards, microSD cards, xD picture cards, and the like, and USB flash drives. In low power implementations, the storage 958 may be on-die memory or registers associated with the processor 952. However, in some examples, the storage 958 may be implemented using a micro hard disk drive (HDD). Further, any number of new technologies may be used for the storage 958 in addition to, or instead of, the technologies described, such resistance change memories, phase change memories, holographic memories, or chemical memories, among others.

The components may communicate over the interconnect 956. The interconnect 956 may include any number of technologies, including industry standard architecture (ISA), extended ISA (EISA), peripheral component interconnect (PCI), peripheral component interconnect extended (PCIx), PCI express (PCIe), or any number of other technologies. The interconnect 956 may be a proprietary bus, for example, used in a SoC based system. Other bus systems may be included, such as an I2C interface, an SPI interface, point to point interfaces, and a power bus, among others.

The interconnect 956 may couple the processor 952 to a mesh transceiver 962, for communications with other mesh devices 964. The mesh transceiver 962 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the mesh devices 964. For example, a WLAN unit may be used to implement Wi-Fi™ communications in accordance with the Institute of Electrical and Electronics Engineers (IEEE) 802.11 standard. In addition, wireless wide area communications, e.g., according to a cellular or other wireless wide area protocol, may occur via a WWAN unit.

The mesh transceiver 962 may communicate using multiple standards or radios for communications at different range. For example, the IoT device 950 may communicate with close devices, e.g., within about 9 meters, using a local transceiver based on BLE, or another low power radio, to save power. More distant mesh devices 964, e.g., within about 50 meters, may be reached over ZigBee or other intermediate power radios. Both communications techniques may take place over a single radio at different power levels, or may take place over separate transceivers, for example, a local transceiver using BLE and a separate mesh transceiver using ZigBee.

A wireless network transceiver 966 may be included to communicate with devices or services in the cloud 900 via local or wide area network protocols. The wireless network transceiver 966 may be a LPWA transceiver that follows the IEEE 802.15.4, or IEEE 802.15.4g standards, among others. The IoT device 950 may communicate over a wide area using LoRaWAN™ (Long Range Wide Area Network) developed by Semtech and the LoRa Alliance. The techniques described herein are not limited to these technologies, but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the mesh transceiver 962 and wireless network transceiver 966, as described herein. For example, the radio transceivers 962 and 966 may include an LTE or other cellular transceiver that uses spread spectrum (SPA/SAS) communications for implementing high speed communications. Further, any number of other protocols may be used, such as Wi-Fi® networks for medium speed communications and provision of network communications.

The radio transceivers 962 and 966 may include radios that are compatible with any number of 3GPP (Third Generation Partnership Project) specifications, notably Long Term Evolution (LTE), Long Term Evolution-Advanced (LTE-A), and Long Term Evolution-Advanced Pro (LTE-A Pro). It can be noted that radios compatible with any number of other fixed, mobile, or satellite communication technologies and standards may be selected. These may include, for example, any Cellular Wide Area radio communication technology, which may include e.g. a 5th Generation (5G) communication systems, a Global System for Mobile Communications (GSM) radio communication technology, a General Packet Radio Service (GPRS) radio communication technology, or an Enhanced Data Rates for GSM Evolution (EDGE) radio communication technology, a UMTS (Universal Mobile Telecommunications System) communication technology, In addition to the standards listed above, any number of satellite uplink technologies may be used for the wireless network transceiver 966, including, for example, radios compliant with standards issued by the ITU (International Telecommunication Union), or the ETSI (European Telecommunications Standards Institute), among others. The examples provided herein are thus understood as being applicable to various other communication technologies, both existing and not yet formulated.

A network interface controller (NIC) 968 may be included to provide a wired communication to the cloud 900 or to other devices, such as the mesh devices 964. The wired communication may provide an Ethernet connection, or may be based on other types of networks, such as Controller Area Network (CAN), Local Interconnect Network (LIN), DeviceNet, ControlNet, Data Highway+, PROFIBUS, or PROFINET, among many others. An additional NIC 968 may be included to allow connect to a second network, for example, a NIC 968 providing communications to the cloud over Ethernet, and a second NIC 968 providing communications to other devices over another type of network.

The interconnect 956 may couple the processor 952 to an external interface 970 that is used to connect external devices or subsystems. The external devices may include sensors 972, such as accelerometers, level sensors, flow sensors, optical light sensors, camera sensors, temperature sensors, a global positioning system (GPS) sensors, pressure sensors, barometric pressure sensors, and the like. The external interface 970 further may be used to connect the IoT device 950 to actuators 974, such as power switches, valve actuators, an audible sound generator, a visual warning device, and the like.

In some optional examples, various input/output (I/O) devices may be present within, or connected to, the IoT device 950. For example, a display or other output device 984 may be included to show information, such as sensor readings or actuator position. An input device 986, such as a touch screen or keypad may be included to accept input. An output device 984 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the IoT device 950.

A battery 976 may power the IoT device 950, although in examples in which the IoT device 950 is mounted in a fixed location, it may have a power supply coupled to an electrical grid. The battery 976 may be a lithium ion battery, or a metal-air battery, such as a zinc-air battery, an aluminum-air battery, a lithium-air battery, and the like.

A battery monitor/charger 978 may be included in the IoT device 950 to track the state of charge (SoCh) of the battery 976. The battery monitor/charger 978 may be used to monitor other parameters of the battery 976 to provide failure predictions, such as the state of health (SoH) and the state of function (SoF) of the battery 976. The battery monitor/charger 978 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 978 may communicate the information on the battery 976 to the processor 952 over the interconnect 956. The battery monitor/charger 978 may also include an analog-to-digital (ADC) convertor that allows the processor 952 to directly monitor the voltage of the battery 976 or the current flow from the battery 976. The battery parameters may be used to determine actions that the IoT device 950 may perform, such as transmission frequency, mesh network operation, sensing frequency, and the like.

A power block 980, or other power supply coupled to a grid, may be coupled with the battery monitor/charger 978 to charge the battery 976. In some examples, the power block 980 may be replaced with a wireless power receiver to obtain the power wirelessly, for example, through a loop antenna in the IoT device 950. A wireless battery charging circuit, such as an LTC4020 chip from Linear Technologies of Milpitas, Calif., among others, may be included in the battery monitor/charger 978. The specific charging circuits chosen depend on the size of the battery 976, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 958 may include instructions 982 in the form of software, firmware, or hardware commands to implement the techniques described herein. Although such instructions 982 are shown as code blocks included in the memory 954 and the storage 958, it may be understood that any of the code blocks may be replaced with hardwired circuits, for example, built into an application specific integrated circuit (ASIC).

In an example, the instructions 982 provided via the memory 954, the storage 958, or the processor 952 may be embodied as a non-transitory, machine readable medium 960 including code to direct the processor 952 to perform electronic operations in the IoT device 950. The processor 952 may access the non-transitory, machine readable medium 960 over the interconnect 956. For instance, the non-transitory, machine readable medium 960 may be embodied by devices described for the storage 958 of FIG. 9 or may include specific storage units such as optical disks, flash drives, or any number of other hardware devices. The non-transitory, machine readable medium 960 may include instructions to direct the processor 952 to perform a specific sequence or flow of actions, for example, as described with respect to the flowchart(s) and block diagram(s) of operations and functionality depicted above.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include, but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together, but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as code rewriting and code analysis) may take place on a different processing system (e.g., in a computer in a data center), than that in which the code is deployed (e.g., in a computer embedded in a sensor or robot). Similarly, operational data may be identified and illustrated herein within components or modules, and may be embodied in any suitable form and organized within any suitable type of data structure. The operational data may be collected as a single data set, or may be distributed over different locations including over different storage devices, and may exist, at least partially, merely as electronic signals on a system or network. The components or modules may be passive or active, including agents operable to perform desired functions.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

Example 1 is a first device for updating a reporting configuration of a second device in a wireless network environment, the first device comprising: processing circuitry; and a storage device comprising instructions, which when executed by the processing circuitry, cause the processing circuitry to perform operations comprising: accessing a current reporting configuration for a second device, wherein the second device transmits sensor data to the first device according to the reporting configuration; measuring network congestion of the wireless network environment surrounding the first device; based on the network congestion and the current reporting interval, determining an updated reporting configuration for the second device; and transmitting an instruction to the second device with the updated reporting interval.

In Example 2, the subject matter of Example 1 optionally includes wherein the current reporting configuration includes a current reporting interval, and the updated reporting configuration includes an updated reporting interval.

In Example 3, the subject matter of Example 2 optionally includes wherein the updated reporting interval is retrieved from a data store based on the network congestion and a type of the second device.

In Example 4, the subject matter of any one or more of Examples 2-3 optionally include wherein measuring, at the first device, network congestion of the wireless network environment includes calculating a success metric for the second device, the success metric based on comparing a number of reports received during the current reporting interval to an expected number of reports for the current reporting interval.

In Example 5, the subject matter of Example 4 optionally includes wherein a report includes the sensor data.

In Example 6, the subject matter of any one or more of Examples 2-5 optionally include wherein the current reporting configuration includes a current number of reports to transmit to the first device during the current reporting interval.

In Example 7, the subject matter of Example 6 optionally includes wherein determining the updated reporting configuration for the second device includes determining an updated number of reports to transmit during the current reporting interval.

In Example 8, the subject matter of Example 7 optionally includes wherein the updated number of reports is an increase from the current number of reports when the success metric is below a threshold.

In Example 9, the subject matter of any one or more of Examples 1-8 optionally include wherein the current reporting configuration includes a target success rate for the second device, and wherein determining the updated reporting configuration for the second device is additionally based on the target success rate.

In Example 10, the subject matter of Example 9 optionally includes wherein the processing circuitry is further configured to perform operations of: accessing, at the first device, a current reporting configuration for a third device, wherein the third device transmits sensor data to the first device according to the current reporting configuration for the third device; and based on the network congestion, the current reporting interval for the third device, and a target success rate for the third device, determining an updated reporting configuration for the third device.

In Example 11, the subject matter of Example 10 optionally includes wherein the updated reporting configuration for the second device includes an increase in a reporting interval and the updated reporting configuration for the third device includes a decrease in a reporting interval.

In Example 12, the subject matter of any one or more of Examples 1-11 optionally include wherein the first device is a gateway device and the second device is a sensor device.

In Example 13, the subject matter of any one or more of Examples 1-12 optionally include wherein the network congestion is measured according to a signal-to-noise ratio.

Example 14 is a method for updating, at a first device, a reporting configuration of a second device in a wireless network environment, the method comprising: accessing, at the first device, a current reporting configuration for a second device, wherein the second device transmits sensor data to the first device according to the reporting configuration; measuring network congestion of the wireless network environment surrounding the first device; based on the network congestion and the current reporting interval, determining an updated reporting configuration for the second device; and transmitting an instruction to the second device with the updated reporting interval.

In Example 15, the subject matter of Example 14 optionally includes wherein the current reporting configuration includes a current reporting interval, and the updated reporting configuration includes an updated reporting interval.

In Example 16, the subject matter of Example 15 optionally includes wherein the updated reporting interval is retrieved from a data store based on the network congestion and a type of the second device.

In Example 17, the subject matter of any one or more of Examples 15-16 optionally include wherein measuring, at the first device, network congestion of the wireless network environment includes calculating a success metric for the second device, the success metric based on comparing a number of reports received during the current reporting interval to an expected number of reports for the current reporting interval.

In Example 18, the subject matter of Example 17 optionally includes wherein a report includes the sensor data.

In Example 19, the subject matter of any one or more of Examples 15-18 optionally include wherein the current reporting configuration includes a current number of reports to transmit to the first device during the current reporting interval.

In Example 20, the subject matter of Example 19 optionally includes wherein determining the updated reporting configuration for the second device includes determining an updated number of reports to transmit during the current reporting interval.

In Example 21, the subject matter of Example 20 optionally includes wherein the updated number of reports is an increase from the current number of reports when the success metric is below a threshold.

In Example 22, the subject matter of any one or more of Examples 14-21 optionally include wherein the current reporting configuration includes a target success rate for the second device, and wherein determining the updated reporting configuration for the second device is additionally based on the target success rate.

In Example 23, the subject matter of Example 22 optionally includes wherein the method further comprises: accessing, at the first device, a current reporting configuration for a third device, wherein the third device transmits sensor data to the first device according to the current reporting configuration for the third device; and based on the network congestion, the current reporting interval for the third device, and a target success rate for the third device, determining an updated reporting configuration for the third device.

In Example 24, the subject matter of Example 23 optionally includes wherein the updated reporting configuration for the second device includes an increase in a reporting interval and the updated reporting configuration for the third device includes a decrease in a reporting interval.

In Example 25, the subject matter of any one or more of Examples 14-24 optionally include wherein the first device is a gateway device and the second device is a sensor device.

In Example 26, the subject matter of any one or more of Examples 14-25 optionally include wherein the network congestion is measured according to a signal-to-noise ratio.

Example 27 is at least one machine-readable medium including instructions, which when executed by a machine, cause the machine to perform operations of any of the methods of Examples 14-26.

Example 28 is an apparatus comprising means for performing any of the methods of Examples 14-26.

Example 29 is an apparatus for updating, at a first device, a reporting configuration of a second device in a wireless network environment, the apparatus comprising: means for accessing, on the first device, a current reporting configuration for a second device, wherein the second device transmits sensor data to the first device according to the reporting configuration; means for measuring network congestion of the wireless network environment surrounding the first device; based on the network congestion and the current reporting interval, means for determining an updated reporting configuration for the second device; and means for transmitting an instruction to the second device with the updated reporting interval.

In Example 30, the subject matter of Example 29 optionally includes wherein the current reporting configuration includes a current reporting interval, and the updated reporting configuration includes an updated reporting interval.

In Example 31, the subject matter of Example 30 optionally includes wherein the updated reporting interval is retrieved from a data store based on the network congestion and a type of the second device.

In Example 32, the subject matter of any one or more of Examples 30-31 optionally include wherein the means for measuring, at the first device, network congestion of the wireless network environment includes means for calculating a success metric for the second device, the success metric based on comparing a number of reports received during the current reporting interval to an expected number of reports for the current reporting interval.

In Example 33, the subject matter of Example 32 optionally includes wherein a report includes the sensor data.

In Example 34, the subject matter of any one or more of Examples 30-33 optionally include wherein the current reporting configuration includes a current number of reports to transmit to the first device during the current reporting interval.

In Example 35, the subject matter of Example 34 optionally includes wherein the means determining the updated reporting configuration for the second device includes means for determining an updated number of reports to transmit during the current reporting interval.

In Example 36, the subject matter of Example 35 optionally includes wherein the updated number of reports is an increase from the current number of reports when the success metric is below a threshold.

In Example 37, the subject matter of any one or more of Examples 29-36 optionally include wherein the current reporting configuration includes a target success rate for the second device, and wherein the means for determining the updated reporting configuration for the second device is additionally based on the target success rate.

In Example 38, the subject matter of Example 37 optionally includes wherein the apparatus further comprises: means for accessing, at the first device, a current reporting configuration for a third device, wherein the third device transmits sensor data to the first device according to the current reporting configuration for the third device; and based on the network congestion, the current reporting interval for the third device, and a target success rate for the third device, means for determining an updated reporting configuration for the third device.

In Example 39, the subject matter of Example 38 optionally includes wherein the means for updated reporting configuration for the second device includes an increase in a reporting interval and the updated reporting configuration for the third device includes a decrease in a reporting interval.

In Example 40, the subject matter of any one or more of Examples 29-39 optionally include wherein the first device is a gateway device and the second device is a sensor device.

In Example 41, the subject matter of any one or more of Examples 29-40 optionally include wherein the network congestion is measured according to a signal-to-noise ratio.

Example 42 is at least one machine-readable medium comprising instructions, which when executed by processing circuitry, cause the processing circuitry to perform operations to update, at a first device, a reporting configuration of a second device in a wireless network environment, the operations comprising: accessing, at the first device, a current reporting configuration for a second device, wherein the second device transmits sensor data to the first device according to the reporting configuration; measuring network congestion of the wireless network environment surrounding the first device; based on the network congestion and the current reporting interval, determining an updated reporting configuration for the second device; and transmitting an instruction to the second device with the updated reporting interval.

In Example 43, the subject matter of Example 42 optionally includes wherein the current reporting configuration includes a current reporting interval, and the updated reporting configuration includes an updated reporting interval.

In Example 44, the subject matter of Example 43 optionally includes wherein the updated reporting interval is retrieved from a data store based on the network congestion and a type of the second device.

In Example 45, the subject matter of any one or more of Examples 43-44 optionally include wherein measuring, at the first device, network congestion of the wireless network environment includes calculating a success metric for the second device, the success metric based on comparing a number of reports received during the current reporting interval to an expected number of reports for the current reporting interval.

In Example 46, the subject matter of Example 45 optionally includes wherein a report includes the sensor data.

In Example 47, the subject matter of any one or more of Examples 43-46 optionally include wherein the current reporting configuration includes a current number of reports to transmit to the first device during the current reporting interval.

In Example 48, the subject matter of Example 47 optionally includes wherein determining the updated reporting configuration for the second device includes determining an updated number of reports to transmit during the current reporting interval.

In Example 49, the subject matter of Example 48 optionally includes wherein the updated number of reports is an increase from the current number of reports when the success metric is below a threshold.

In Example 50, the subject matter of any one or more of Examples 42-49 optionally include wherein the current reporting configuration includes a target success rate for the second device, and wherein determining the updated reporting configuration for the second device is additionally based on the target success rate.

In Example 51, the subject matter of Example 50 optionally includes wherein the operations further comprise: accessing, at the first device, a current reporting configuration for a third device, wherein the third device transmits sensor data to the first device according to the current reporting configuration for the third device; and based on the network congestion, the current reporting interval for the third device, and a target success rate for the third device, determining an updated reporting configuration for the third device.

In Example 52, the subject matter of Example 51 optionally includes wherein the updated reporting configuration for the second device includes an increase in a reporting interval and the updated reporting configuration for the third device includes a decrease in a reporting interval.

In Example 53, the subject matter of any one or more of Examples 42-52 optionally include wherein the first device is a gateway device and the second device is a sensor device.

In Example 54, the subject matter of any one or more of Examples 42-53 optionally include wherein the network congestion is measured according to a signal-to-noise ratio.

Example 55 is at least one machine-readable medium including instructions that, when executed by a processor, cause the processor to perform operations to implement of any of Examples 1-54.

Example 56 is an apparatus comprising means to implement of any of Examples 1-54.

Example 57 is a system to implement of any of Examples 1-54.

Example 58 is a method to implement of any of Examples 1-54.

In the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment.

What is claimed is:

1. A first device for updating a reporting configuration of a second device in a wireless network environment, the first device comprising:
processing circuitry; and
a storage device comprising instructions, which when executed by the processing circuitry, cause the processing circuitry to perform operations comprising:
accessing a current reporting configuration for a second device, wherein the second device transmits sensor data to the first device according to the reporting configuration;
measuring network congestion of the wireless network environment surrounding the first device;
based on the network congestion and the current reporting interval, determining an updated reporting configuration for the second device; and
transmitting an instruction to the second device with the updated reporting interval.

2. The first device of claim 1, wherein the current reporting configuration includes a current reporting interval, and the updated reporting configuration includes an updated reporting interval.

3. The first device of claim 2, wherein the updated reporting interval is retrieved from a data store based on the network congestion and a type of the second device.

4. The first device of claim 2, wherein measuring, at the first device, network congestion of the wireless network environment includes calculating a success metric for the second device, the success metric based on comparing a number of reports received during the current reporting interval to an expected number of reports for the current reporting interval.

5. The first device of claim 4, wherein a report includes the sensor data.

6. The first device of claim 2, wherein the current reporting configuration includes a current number of reports to transmit to the first device during the current reporting interval.

7. The first device of claim 6, wherein determining the updated reporting configuration for the second device includes determining an updated number of reports to transmit during the current reporting interval.

8. The first device of claim 7, wherein the updated number of reports is an increase from the current number of reports when the success metric is below a threshold.

9. The first device of claim 1, wherein the current reporting configuration includes a target success rate for the second device, and wherein determining the updated reporting configuration for the second device is additionally based on the target success rate.

10. The first device of claim 9, wherein the processing circuitry is further configured to perform operations of:
accessing, at the first device, a current reporting configuration for a third device, wherein the third device transmits sensor data to the first device according to the current reporting configuration for the third device; and
based on the network congestion, the current reporting interval for the third device, and a target success rate for the third device, determining an updated reporting configuration for the third device.

11. The first device of claim 10, wherein the updated reporting configuration for the second device includes an increase in a reporting interval and the updated reporting configuration for the third device includes a decrease in a reporting interval.

12. The first device of claim 1, wherein the first device is a gateway device and the second device is a sensor device.

13. The first device of claim 1, wherein the network congestion is measured according to a signal-to-noise ratio.

14. A method for updating, at a first device, a reporting configuration of a second device in a wireless network environment, the method comprising:
accessing, at the first device, a current reporting configuration for a second device, wherein the second device transmits sensor data to the first device according to the reporting configuration;
measuring network congestion of the wireless network environment surrounding the first device;
based on the network congestion and the current reporting interval, determining an updated reporting configuration for the second device; and
transmitting an instruction to the second device with the updated reporting interval.

15. The method of claim 14, wherein the current reporting configuration includes a current reporting interval, and the updated reporting configuration includes an updated reporting interval.

16. The method of claim 15, wherein the updated reporting interval is retrieved from a data store based on the network congestion and a type of the second device.

17. The method of claim 15, wherein measuring, at the first device, network congestion of the wireless network environment includes calculating a success metric for the second device, the success metric based on comparing a number of reports received during the current reporting interval to an expected number of reports for the current reporting interval.

18. The method of claim 17, wherein a report includes the sensor data.

19. The method of claim 15, wherein the current reporting configuration includes a current number of reports to transmit to the first device during the current reporting interval.

20. The method of claim 19, wherein determining the updated reporting configuration for the second device includes determining an updated number of reports to transmit during the current reporting interval.

21. The method of claim 20, wherein the updated number of reports is an increase from the current number of reports when the success metric is below a threshold.

22. The method of claim 14, wherein the current reporting configuration includes a target success rate for the second device, and wherein determining the updated reporting configuration for the second device is additionally based on the target success rate.

23. The method of claim 22, wherein the method further comprises:
accessing, at the first device, a current reporting configuration for a third device, wherein the third device transmits sensor data to the first device according to the current reporting configuration for the third device; and
based on the network congestion, the current reporting interval for the third device, and a target success rate for the third device, determining an updated reporting configuration for the third device.

24. At least one machine-readable medium comprising instructions, which when executed by processing circuitry, cause the processing circuitry to perform operations to update, at a first device, a reporting configuration of a second device in a wireless network environment, the operations comprising:
accessing, at the first device, a current reporting configuration for a second device, wherein the second device transmits sensor data to the first device according to the reporting configuration;
measuring network congestion of the wireless network environment surrounding the first device;
based on the network congestion and the current reporting interval, determining an updated reporting configuration for the second device; and
transmitting an instruction to the second device with the updated reporting interval.

25. The at least one machine-readable medium of claim 24, wherein the current reporting configuration includes a current reporting interval, and the updated reporting configuration includes an updated reporting interval
